(19) United States
(12) Patent Application Publication
(10) Pub. No.: US 2010/0000619 A1
(43) Pub. Date: Jan. 7, 2010

(54) SLURRY VALVE

(76) Inventor: DAVID BRYAN LARSON, BROKEN ARROW, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/165,787

(22) Filed: Jul. 1, 2008

(51) Int. Cl. F16K 11/072; B23P 6/00

(52) U.S. Cl. 137/625.46; 29/890.121

(57) ABSTRACT

A multi-way valve suitable for use with large particle abrasive slurries. The valve has a housing and a seat piece affixed to the housing that defines a chamber. The seat piece has a conical valve seat. A rotor defines a conical base end that is received in the conical valve seat. A spring member biases the conical base end of the rotor against the conical valve seat to center the rotor and to allow the rotor to glide over large particles and for compensating for wear of the rotor over the lifetime of said rotor. The rotor has a first fluid path that is over a top of the rotor and a second fluid path that is through a bridge passageway in the rotor, thereby pressure balancing said rotor. The first fluid path provides continual flushing of particles from the chamber.

### FIELD OF THE INVENTION

The present invention relates to valves for use in the conveyance and directional control of abrasives-laden fluids, and more particularly to valve elements for use in contamination prone environments such as those found in construction, mining, or mineral processing equipment and laboratory instruments.

### BACKGROUND OF THE INVENTION

Valves are designed to selectively seal one port from another. High pressure valves are typically designed with very small clearances and fine sealing surfaces. When used with abrasive slurries, highly polished surfaces of high pressure valves are easily damaged by solids, causing the surfaces to no longer seal or resulting in mechanical binding of the rotating or sliding components. Subjecting a valve to abrasive solids presents difficulties since abrasive solids tend to grind away at valve bearings and sealing surfaces causing then to fail by leaking or mechanical binding. Generally, smaller valves can only tolerate small particles.

Because of the wear issues, difficulties were encountered when attempting to locate a suitable four-way valve for directional control of slurries. Several common valves were considered for this purpose. Three-way ball valves were configured to make a four-way circuit. The ball valves were plumbed into a fluid test circuit and run less than 720 cycles before excessive torque caused them to fail. Disassembly and inspection of the components revealed that solids contamination of the bearings and rotating surfaces caused them to bind and fail. The bearings, shaft, and all sealing surfaces were damaged by the abrasive solids. A plunger type cone and seat design with an air actuator was also tested. This valve survived less than 12 cycles before failure.

### SUMMARY OF THE INVENTION

It is desirable to provide a valve suitable for use in high temperatures and pressure applications for four-way directional control of solids-laden slurries. The valve of the invention is designed to handle relatively large particle sizes while eliminating the problems commonly associated with abrasive solids. In addition, the valve can be constructed of temperature, corrosion and abrasion resistant materials for use in harsh environments.

For some applications, a four-way directional control valve for applications involving corrosive, solids-laden slurries at high temperatures and pressures may be needed. In one example, the function of such a valve is to control flow direction of fluids from one accumulator to another when operated in a reciprocating manner.

The slurry valve of the present invention includes a pressure housing having a cone shaped rotor that fits precisely into a conical four-port valve seat. Ports on the rotor align with ports on the valve seat to direct the flow path. The rotor may be actuated 90 degrees by a shaft or stem, causing a selected pair of ports to be in communication with one another. The ports may be designated A, B, C, and D. In position 1, ports A-B and C-D are connected. In position 2, ports A-D and B-C are connected.

The rotor is spring loaded against the valve seat with sufficient force to effect a seal between adjacent ports. The rotor is constructed of an abrasion resistant material to resist wear. The rotor is also pressure balanced so that torque requirements and sealing forces are independent from system pressure changes. The spring loading of the rotor also allows the rotor to float over large particles without binding. The valve is constructed of high temperature, corrosion resistant materials for use in harsh environments. The design facilitates easy service and repair.

### BRIEF DESCRIPTION OF THE DRAWINGS

FIG. 1 is a cross-sectional side view of the HPHT four-way slurry valve of the invention.

FIG. 2 is a cross-sectional bottom view of the valve of FIG. 1, taken along line 2-2 of FIG. 1.

FIG. 3 is a bottom view of the valve of FIG. 1 showing a schematic of the flow paths when the rotor is in position 1.

FIG. 4 is a bottom view of the valve of FIG. 1 showing a schematic of the flow paths when the rotor is in position 2.

FIG. 5 is a perspective view of the conical base end of the rotor of the present invention.

FIG. 6 is a perspective view of the stem end of the rotor of the present invention.

### DETAILED DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

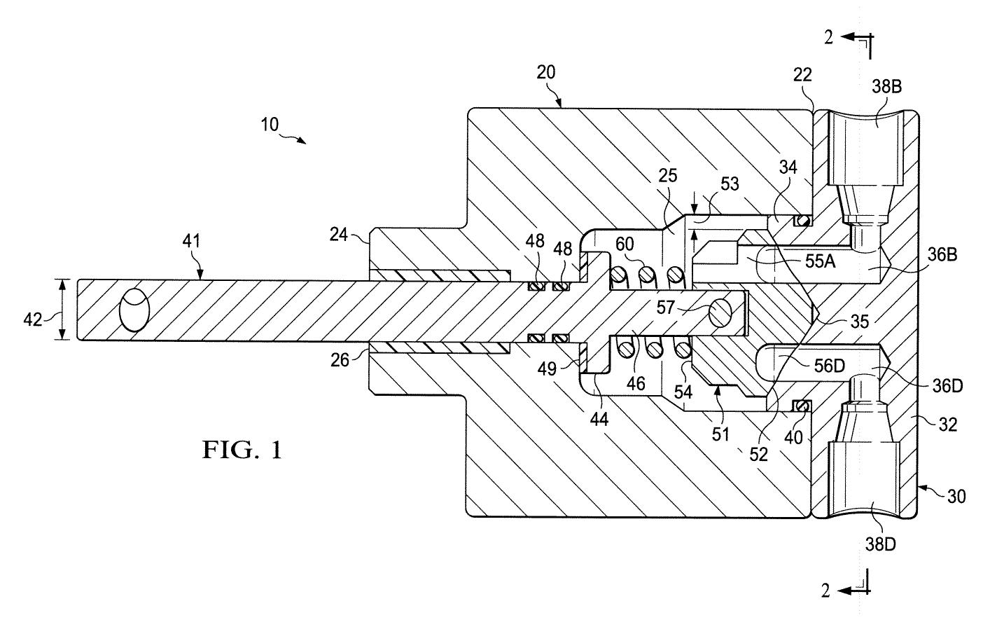

Referring first to FIG. 1, shown is the four-way valve 10 of the invention. Valve 10 has a housing 20 having a base end 22 and a stem end 24. Housing 20 defines a receptacle 25 in base end 22 and a longitudinal passageway that communicates stem end 24 with the receptacle. Bushing 26 is received within the longitudinal passageway proximate stem end 24 of housing 20.

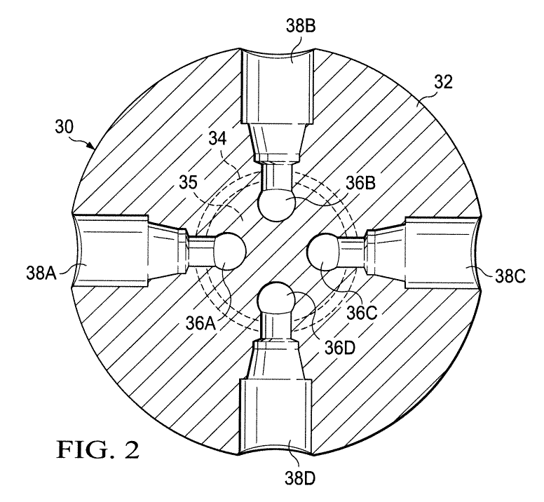

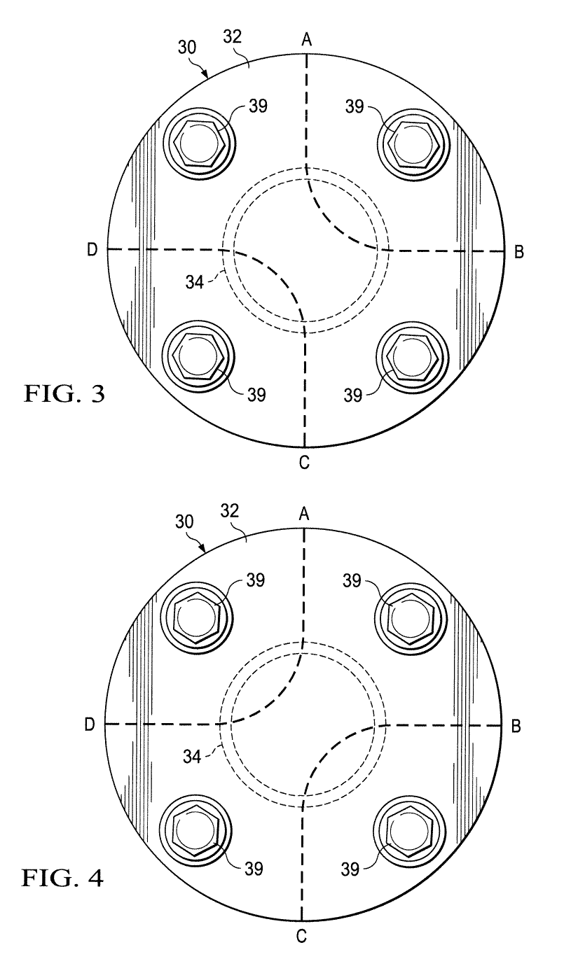

A seat piece 30 (FIGS. 1, 2) is received on base end 22 of housing 20. Seat piece 30 has a base flange portion 32 and a central insertion portion 34. Central insertion portion 34 is received within receptacle 25 of housing 20. Central insertion portion 34 of seat piece 30 has a conical valve seat 35 (FIG. 1), thereon. Valve seat 35 has a conical surface that defines four ports that lead to four longitudinal passageways, i.e., passageways 36A, 36B, 36C, and 36D. Base flange portion 32 defines radial passageways leading to exterior ports, i.e., radial passageway 38A, radial passageway 38B, radial passageway 38C, and radial passageway 38D. Seat piece 30 and housing 20 are bolted together with bolts 39 (FIGS. 3, 4) to make up a pressure housing of valve 10. Seat piece 30 and housing 20 are sealed with an elastomeric seal 40 (FIG. 1). Seat piece 30 and housing 20 are constructed of materials having sufficient strength and other properties for the intended service.

A stem 41 has a first diameter portion 42, a flange 44, and a second diameter portion 46. First diameter portion 42 passes through the longitudinal passageway of housing 20 and through bushing 26. Flange 44 is adjacent an interior wall of receptacle 25 of housing 20. Second diameter portion 46 of stem 41 extends into receptacle 25. Sealing members, such as O-rings 48, surround stem 41 for forming a pressure seal between stem 41 and the longitudinal passageway of housing 20.

Radial support for stem 41 is provided by bushing 26, and axial support is provided by thrust washer 49. Thrust washer 49 provides two functions. First, thrust washer 49 provides axial support of stem 41 when hydraulic pressure and spring forces are applied. Thrust washer 49 also serves as a wiper or pre-seal to exclude particles from contaminating the running clearance between stem 41 and housing 20. Thrust washer 49 also minimizes particle contamination of o-rings 48. Thrust washer 49 is preferably constructed of an abrasion resistant polymer material with self-lubricating properties for low friction.

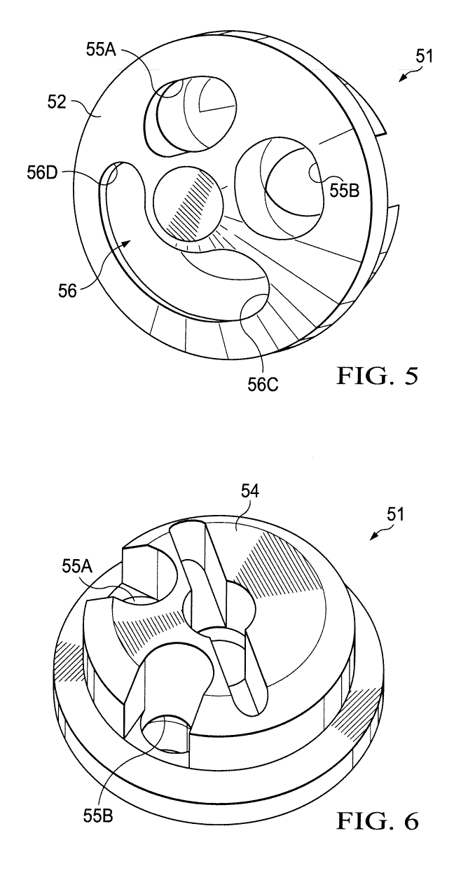

Rotor 51 (FIGS. 1, 5, 6) is located within the receptacle of housing 20. In a preferred embodiment, a clearance 53 (FIG. 1) is provided between an outer surface of rotor 51 and inside surface of housing 20. Clearance 53 should be sufficiently larger than the maximum particle size for which the valve is designed to prevent potential bridging or binding of rotor 51. Although the size of clearance 53 may differ in various applications, it is desirable for clearance 53 to be approximately four times the anticipated particle size. Rotor 51 is actuated by stem 41. Torque applied to stem 41 is transmitted to rotor 51 via pin 57 which engages both parts. Rotor 51 has a conical base end 52 (FIGS. 1, 5) for locating in conical seat 35 of seat piece 30. Conical base end 52 of rotor 51 is shaped to mate precisely with the conical valve seat 35. Rotor 51 has stem end 54 (FIGS. 1, 6) that defines a stem receptacle for receiving an end of second diameter 46 of said stem 41, as shown in FIG. 1. Pin 57 secures rotor 51 to stem 41 so that rotor 51 rotates with said stem 41. As can best be seen in FIGS. 5 and 6, rotor 51 defines a first rotor passageway 55A, a second rotor passageway 55B, and a partial circumferential bridge passageway 56 formed in conical base end 52. Partial circumferential bridge passageway 56 has first port end 56C and a second port end 56D.

Referring back to FIG. 1, spring 60 surrounds said second diameter 46 of said stem 41. Spring 60 is engaged with flange 44 of stem 41 on a first end and is engaged with stem end 54 of rotor 51 on a second end. Spring 60 applies a force to rotor 51 for facilitating tight engagement of conical base end 52 of rotor 51 against conical valve seat 35 of said seat piece 30. Therefore, rotor 51 is axially loaded against valve seat 36 using spring 60 with sufficient force to affect a port-to-port seal.

Stem 41 may be rotated for rotating rotor 51 for locating rotor 51 in a one of a first rotational position (FIG. 3) or a second rotational position (FIG. 4). When rotor 51 is positioned in the first rotational position, ports corresponding to radial passageways 38A and 38B are connected via partial circumferential bridge passageway 56 and ports corresponding to radial passageways 38C and 38D are connected via first rotor passageway 55A (FIGS. 1, 5, 6) and second rotor passageway 55B (FIGS. 5, 6). In the embodiment shown and discussed above, radial passageways 38A-D are hydraulically connected in adjacent pairs to provide a four-way directional control circuit. Ports 56C and 56D of bridge passageway 56 are hydraulically connected across a face of conical base end 52 of rotor 51. Rotor passageways 55A and 55B hydraulically connect a face of conical base end 52 through to the opposite side of rotor 51. This hydraulic path provides pressure balancing of rotor 51 as well as a continuous flushing of particles from the valve housing 20 when in service. When rotor 51 is rotated 90 degrees to the second rotational position (FIG. 4), radial passageways 38A and 38D are connected via partial circumferential bridge passageway 58 and radial passageways 38B and 38C are connected via first rotor passageway 55A and second rotor passageway 55B.

In the present configuration, rotor 51 is designed to operate in two positions, 90 degrees apart. The present configuration provides a four-way direction control circuit. In position 1, radial passageways 38A-B and 38C-D are hydraulically connected. In position 2, radial passageways 38A-D and 38B-C are hydraulically connected. In the embodiment shown, two ports associated with radial passageways 38A-D are slowly closing during rotation while the other two ports associated with radial passageways 38A-D slowly open. This prevents pressure spikes during rotation. Radial alignment is provided by the mating of the two conical surfaces 36, 52. In a preferred embodiment, the angle of the mating cone shaped components 36 and 52 is 30 degrees. The angle is designed to give sufficient centering forces for rotor 51 when rotor 51 and seat piece 30 are pressed together by the loading forces of the axial spring 60. Rotor 51 is preferably constructed of an abrasion resistant, self-lubricating material that is chemically resistant to the fluids and service temperature, such as graphite filled polyetheretherketone (PEEK). Port-to-port sealing effectiveness is dependent on the precision and surface finish of the mating cone 52 and seat 30 and the normal force between the components. Rotor 51 is able to float axially to provide axial compliance if particles become entrapped between the sealing surfaces of conical valve seat 36 and a face of conical base end 52.

The fundamental valve design is uniquely flexible and scalable. Although the present configuration provides four-way directional control of slurries, the same design principles could readily be applied to an unlimited number of port configurations such as two-way, three-way, five-way, etc. Alternate materials could be used based on the necessary strength requirement and corrosion properties. Size is also scalable to accommodate various flow rates or slurry properties.

One feature of the present invention includes cone shaped rotor 51. The rotor 51 of the invention provides centralization and stability of rotor 51. It is contemplated that valves having different shaped rotor and seat combinations such as flat or spherical, etc., may also be possible.

Another feature of the present invention is large clearances around the rotor. The present invention has very large clearances around the rotor. This feature is essential for accommodating large particles without binding or becoming trapped.

A third feature of the present invention is that pressure balance is achieved by having two ports connecting and flowing across the back side or stem end 54 of rotor 51 to counteract two ports on the front side or conical base end 52 of the rotor 51. The balanced pressure promotes a constant rotor to seat sealing pressure which is provided by spring 60. Spring 60 allows enough axial motion so that rotor 51 can ride up over particles rather than shear them or have them bind as rotor 51 is actuated.

An additional feature of the present invention is flushing. The flow path across the top of the rotor continually flushes all cavities of the valve, thus eliminating the potential for particles to become trapped or lodged.

A further feature of the present invention is that it has remarkably few parts, making it easy to service or rebuild.

Additionally, the valve of the present invention is configurable for use over a broad temperature range. It is also suitable over a broad pressure range, including extremely high pressures.

Further, the materials of construction for the valve design of the present invention are readily tailored to accommodate a broad range of chemical exposure. The size of the valve is scalable to accommodate various flow capacities.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A multi-way valve suitable for use with large particle, abrasive slurries comprising the following:
a housing having a base end and a stem end, said housing defining a receptacle on said base end and a longitudinal passageway communicating said stem end with said receptacle;
a seat piece affixed to said housing, said seat piece having a conical valve seat;
a rotor received in said housing, said rotor having a conical base end for locating in said conical valve seat of said seat piece;
a spring member for biasing said rotor against said conical valve seat;
wherein said mating engagement of said conical valve seat and said conical base end of said rotor function to center said rotor on said valve seat; and
wherein said spring member may be flexed to allow said rotor to glide over large particles between said rotor and said valve seat rather than grinding said particles or binding the rotor, said spring also for compensating for wear of said rotor over the lifetime of said rotor.

2. The valve according to claim 1 wherein:
said rotor defines a plurality of rotor ports;
said valve seat defines a plurality of valve seat ports; and
said rotor may be rotated to selectively match up selected ones of said rotor ports with selected ones of said valve seat ports.

3. The valve according to claim 2 wherein:
said rotor defines a first through passageway that communicates with a first one of said rotor ports, said rotor defines a second through passageway that communicates with a second one of said rotor ports, said rotor further defines a bridge passageway that communicates with a third one of said rotor ports at a first end and communicates with a fourth one of said rotor ports at a second end;
wherein said valve seat defines a first passageway that communicates with a first one of said valve seat ports, said valve seat defines a second passageway that communicates with a second one of said valve seat ports, said valve seat defines a third passageway that communicates with a third one of said valve seat ports, said valve seat defines a fourth passageway that communicates with a fourth one of said valve seat ports;
when selected pairs of rotor ports are matched up with selected pairs of valve seat ports, a first fluid path is over a top of said rotor and a resulting second fluid path is through said bridge passageway of said rotor, thereby pressure balancing said rotor for maintaining consistent port-to-port sealing forces independent of system pressure and for eliminating torque variation due to system pressure change.

4. The valve according to claim 3 wherein:
said first fluid path provides continual flushing of particles from a chamber defined by said housing.

5. The valve according to claim 1 further comprising:
a stem passing into said housing, said stem affixed to said rotor, said stem having a flanged portion for engaging said base end of said housing;
a pressure seal in said longitudinal passageway between said stem and said housing;
a thrust washer between said flanged portion of said stem and said housing, said thrust washer functioning as a thrust bearing and pre-seal to keep abrasive particles away from said pressure seal.

6. A multi-way valve suitable for use with large particle, abrasive slurries comprising the following:
a housing having a base end and a stem end, said housing defining a receptacle on said base end and a longitudinal passageway communicating said stem end with said receptacle;
a seat piece affixed to said base end of said housing, said seat piece having a conical valve seat and defining a plurality of valve seat passageways;
a rotor received in said receptacle of said housing, said rotor having a conical base end for locating in said conical valve seat of said seat piece, said rotor defining a plurality of rotor passageways, wherein said rotor may be rotated to selectively match up selected ones of said rotor passageways with selected ones of said valve seat passageways.

7. The valve according to claim 6 further comprising:
a spring member for biasing said rotor against said conical valve seat;
wherein mating engagement of said conical valve seat and said conical base end of said rotor function to center said rotor on said conical valve seat; and
wherein said spring member may be flexed to allow said rotor to glide over large particles between said rotor and said conical valve seat rather than grinding said particles or binding the rotor, said spring member also for compensating for wear of said rotor over the lifetime of said rotor.

8. The valve according to claim 7 wherein:
said rotor passageways comprise a first rotor passageway in communication with a first rotor port, a second rotor passageway in communication with a second rotor port, a bridge passageway in communication with a third rotor port at a first end and in communication with a fourth rotor port at a second end;
wherein said valve seat passageways communicate with valve seat ports on a face of said conical valve seat;
when selected pairs of said rotor ports and said valve seat ports are matched up, a resulting first fluid path is over a top of said rotor and a resulting second fluid path is through said bridge passageway of said rotor, thereby pressure balancing said rotor for maintaining consistent port-to-port sealing forces independent of system pressure, and for eliminating torque variation due to system pressure change.

9. The valve according to claim 8 wherein:
said receptacle of said housing is enclosed by affixing said seat piece on said base end of said housing to form a chamber; and
said first fluid path provides continual flushing of particles from said chamber during operation.

10. The valve according to claim 6 further comprising:
a stem passing into said housing, said stem affixed to said rotor, said stem having a flanged portion for engaging an inside surface of said receptacle in said housing;
a pressure seal between said stem and said housing;
a thrust washer between said flanged portion of said stem and said inside surface of said receptacle in said housing, said thrust washer functioning as a thrust bearing and pre-seal to keep abrasive particles away from said pressure seal.

11. A method of adapting a valve to handle large particle, abrasive slurries comprising the steps of:
receiving a conical surface of a rotor in a conical surface of a valve seat;
biasing said rotor against said valve seat with a spring member, wherein said mating engagement of said valve seat and said rotor function to center said rotor on said valve seat; and
flexing said spring member to allow said rotor to glide over large particles between said rotor and said valve seat rather than grinding said particles or binding the rotor, and for compensating for wear of said rotor over the lifetime of said rotor.

12. The method according to claim 11 further comprising the steps of:
rotating said rotor to selectively match up selected ones of a plurality of rotor ports defined by said rotor with selected ones of valve seat ports defined by said valve seat.

13. The method according to claim 12 further comprising the steps of:
directing a first fluid path over a top of said rotor; and
directing a second fluid path through a bridge passageway formed in said rotor, thereby pressure balancing said rotor for maintaining consistent port-to-port sealing forces independent of system pressure, and eliminating torque variation due to system pressure change.

14. The valve according to claim 13 further comprising the step of:
continually flushing particles from a chamber defined by a housing in which said rotor is located.

15. The method according to claim 11 further comprising the step of:
locating a thrust bearing and pre-seal inside a housing in which said rotor is located to keep abrasive particles away from a pressure seal between a stem and said housing.
